(19) United States
(12) Patent Application Publication
(10) Pub. No.: US 2008/0177468 A1
(43) Pub. Date: Jul. 24, 2008

(54) Search function for portable navigation device

(76) Inventors: Ingrid Halters, Amsterdam (NL); Van Raamsdonk Ewoud, Utrecht (NL); Simone Tertoolen, Amsterdam (NL)

Correspondence Address: TOMTOM INTERNATIONAL B.V., REMBRANDTPLEIN 35, AMSTERDAM, 1017CT, omitted

(21) Appl. No.: 12/007,380

(22) Filed: Jan. 9, 2008

Related U.S. Application Data
(60) Provisional application No. 60/879,591, filed on Jan. 10, 2007.

(51) Int. Cl. G01C 21/26; G06F 3/048

(52) U.S. Cl. 701/208; 715/808

(57) ABSTRACT

A portable navigation device or navigation system along with a method of operating it and a computer program for controlling it are described. The device or system includes a display, memory, processor, wireless signal receptors, and a user interface. The memory includes one or more map data files having digitized map data and descriptive data identifying features represented within the digitized map data, and the device or system includes software capable of performing navigation between a current location determined from the wireless signals received, and a destination at least partially identified by the user input. The software also includes an address finding facility which when selected, causes display of at least one address portion identifier together with a first sorted list of alphanumeric characters.

### PRIORITY STATEMENT

The present application hereby claims priority under 35 U.S.C. §119(e) on U.S. Provisional Patent Application No. 60/879,591 filed Jan. 10, 2007, the entire contents of which is hereby incorporated herein by reference.

### BACKGROUND OF THE INVENTION

This invention relates to an improved search function, and more specifically to an improved search function for a portable navigation device (PND) or navigation system which possesses a screen for information display and which enables user selection of one or more items displayed thereon to provide an input for said PND or system.

Although the following description relates predominantly to PNDs, the reader will appreciate that this invention may apply equally to embedded or integrated navigation systems which are now being provided as standard or as an optional extra in mass produced vehicles. Additionally, the invention may apply to mobile telephones and personal digital assistants (PDAs), and indeed any device which combines processing capability, memory, and global positioning system (GPS) signal reception means and can thus effectively operate as a PND.

Portable navigation devices (PNDs) typically include a processor, memory (both ROM and RAM), a display, GPS wireless signal reception means, and operate under the control of a software operating system which:
provides the various navigation and ancillary functions provided by the device,
allows for user input either through a touch-sensitive screen or other input means, and,
processes user input, along with wirelessly received signals, to cause the display of information for simply, quickly and effectively achieving the display of map information, navigation and ancillary functions.

In this regard, it is common for PNDs to maintain lists in memory of the most recent destinations entered by the user and to which navigation has previously been performed. This functionality can extend to cities, points of interest (POIs), addresses, road intersections, categories of any of these, and indeed any information which the user enters which is indicative of a destination to which navigation may subsequently be desired.

In particular, modern PNDs include digital map data, along with one or more databases containing descriptive data identifying every road, street, motorway, postcode, and POI appearing on the digitally represented map. The user interface provided by the operating system software, or a further program executing on the operating system software, may provide a facility whereby a user can cause a menu to be displayed including a navigation option, which when selected provides a number of different destination setting options. These options include selecting a city, an intersection, an address, a POI, or in certain instances, specific latitude and longitude coordinates, and the user interface may, for one or more of these options, offer the facility to select from a list of most recently visited or entered destinations, as well as a means for entering alphanumeric characters on-screen, which may be displayed in conjunction with an excerpt of the most recently visited list, or may be displayed separately therefrom.

The user entry of alphanumeric characters is of course the primary source of data for the device, as addresses, postcodes, cities and the like are identified in the device databases by such characters. In the case of cities, the user is typically requested to enter the first few characters of the name of the city by means of a displayed virtual keyboard on the touch sensitive screen, whereupon the software performs a search in the city name database for matching names. The type of search may be a simple “begins with” type search, in which only cities having names beginning with the characters entered by the user are displayed, or the search may be a more advanced search, such as a “contains” search, possibly combined with the “begins with” search, the execution of which provides results having city names containing (and beginning with) the user-entered characters. Other search strategies may of course be applicable.

This search function is performed as each character is entered, the search results are updated accordingly, and the set of results displayed in scrollable list format. Of course, as the display screens of PNDs tend to be small (typically less than 20 cm square), the portion of the screen dedicated to the display of the list will also be small, and therefore means are also displayed on screen which allow the user to scroll through the list, such as simple “up” and “down” on-screen arrow buttons. Any contact the user makes with the screen in the region of said buttons causes the displayed virtual keyboard to be hidden, and more entries in the list to be displayed, and accordingly of later or earlier items in the sorted list may be displayed.

In general, on current devices, in particular those available from the applicant herefor at the time of filing hereof, specific address entry, either for the purpose of selecting a particular destination, or setting a home or other “favourite” location, is effected firstly by entering a city, town or village name, followed by a street or road name, and finally a building name or number may be entered to pinpoint the desired address. The entry of these separate pieces of information occurs in identical manner as described above.

Although this means of entering information is considered sufficient, it is often considered slightly laborious, and an improved means of address entry is desired.

Accordingly, it is an object of this invention to provide PNDs and navigation systems with an improved means of address entry.

### SUMMARY OF THE INVENTION

According to the present invention, there is provided a PND or navigation system comprising a display, memory, processing means, wireless signal reception means, and means for receiving user input, said memory including one or more map data files containing digitized map data and descriptive data identifying features represented within said digitized map data, said PND including software capable of performing navigation between a current location determined from the wireless signals received, and a destination at least partially identified by said user input, characterised in that said software includes an address finding facility which when selected, causes display of at least one address portion identifier together with a first sorted list of consecutive alphanumeric characters being both selectable and representing either
the first alphanumeric character of the address portion identifier desired to be entered by the user, or
a first range of alphanumeric characters between which the address portion identifier desired to be entered by the user exists,

selection of an entry in said first list causing display of a second list of alphanumeric characters, entries in said second list also being selectable and including either
the first previously selected alphanumeric character and at least one further alphanumeric character, said further alphanumeric character consecutively changing in said second list, or
a second narrower range of alphanumeric characters within which the address portion identifier desired to be entered by the user exists, or
individual consecutive alphanumeric characters previously represented by the first range,

selection of an entry in said second list causing either identification of the address portion identifier desired to be entered by the user, or the display of further lists being progressively more specific as a result of the user selection of entries in previously displayed lists until selection of an entry in one of the displayed further lists results in such identification.

Preferably, in the case where the address portion identifier is alphabetically represented, the first list consists of a plurality of entries being the consecutive letters of the alphabet and the second list consists of entries being the alphabetical character selected from the first list by the user suffixed by a consecutively changing alphabetical character.

Preferably, the selection of an entry from the second list causes a search to be conducted of the descriptive data stored in the device for the particular address portion identifier currently being identified, said search being of the “begins with” type and including the two alphabetic characters previously selected from the second list, such that the subsequently displayed further list contains entries consisting of said two alphabetic characters suffixed by at least one or a combination of the following:
one further alphabetic character in the event that the search result of descriptive data includes more than a single entry for address portion identifier names beginning with the previously selected two alphabetic characters and having said further alphabetic character as a third character,
full address portion identifier names in the event that the search result of descriptive data includes only a single entry for address portion identifier names beginning with the previously selected two alphabetic characters and having said further alphabetic character as a third character.

Most preferably, in the case that a further list of selectable entries is displayed after selection from the previous second list of consecutive pairs of alphabetic characters, the first three alphabetic characters of entries in said further list is displayed differently to the remainder of any fully displayed address portion identifier name.

Preferably, in the first list, the alphabetic character is displayed capitally. Further preferably, in the second list, the first, previously selected character is displayed capitally and the second consecutively changing character is displayed adjacent the first character and in lower case.

Most preferably, any of the first, second and further lists are scrollable in the event that the entirety of the list cannot be displayed on the display screen of the device. In a preferred arrangement, the list is scrollable by means of a draggable scroll bar additionally displayed on the display screen, such being touch sensitive to allow a user to virtually touch, hold and drag said scroll bar and thus cause display of entries in the list not capable of being displayed on account of the size of the screen.

In an alternative arrangement, one entry in any of the first, second and further lists is displayed with a highlight indication, and the PND or navigation system is provided with a physical control by means of which the user can scroll through the list, preferably a scroll wheel control, operation of such causing the highlight indication to move in one direction or another depending on control movement direction and thus achieving a scroll effect.

Preferably, the address portion identifier displayed is one of a city name, a street or road name or indicator, a house or building number or name, or an intersection name or indicator.

In the case where the address portion identifier is numeric, preferably, the first, second or further lists consist of at least some entries representing a range of numbers, each of which is selectable to cause display of a second or further list having either
selectable entries representing a plurality of narrower ranges which collectively cover all the numbers represented by the selected entry in the first list,
selectable entries being individual numeric values

selection of said entries in said second or further list causing either display of a further list having either of the above entry types or identification of the desired address portion identifier to the device, which in conjunction with the other selections previously made, contributes to the overall identification of an address location.

In a most preferred arrangement, the specific identification of an address portion identifier of an alphabetic type causes the address finding facility to repeat the process, either for a more specific address portion identifier, or for a numeric address portion identifier type.

Most preferably, in the case where the address portion identifier is numeric, for example being a house or building number, and a prior selection of an alphatebetic address portion identifier has been made, the first list preferably additionally includes one or more alternate entries, distinct from the numeric range entries, which allow a user to forgo entry of a specific number.

Preferably, one of the alternate list entries is an “anywhere” entry, selection of which results in automatic indication to the device that anywhere on the previously selected alphabetic address portion identifier is acceptable as a location.

Preferably, one of the alternate list entries is an “crossing” entry, selection of which results in display of a further list of alphabetically sorted street or road names crossing or otherwise intersecting with a previously selected alphabetic address portion identifier, selection of any of said entries then result in the identification of a specific location.

A method of operating a PND, navigation system, or mobile device is also provided, as is a computer program by means of which such much be implemented.

A specific description of the invention will now be provided with reference to the accompanying drawings wherein:

### BRIEF DESCRIPTION OF SEVERAL VIEWS OF THE DRAWINGS

FIGS. 1-14 show various different screen shots of the user interface of a PND or other GPS-enabled device adapted for the present invention.

### DETAILED DESCRIPTION OF THE INVENTION

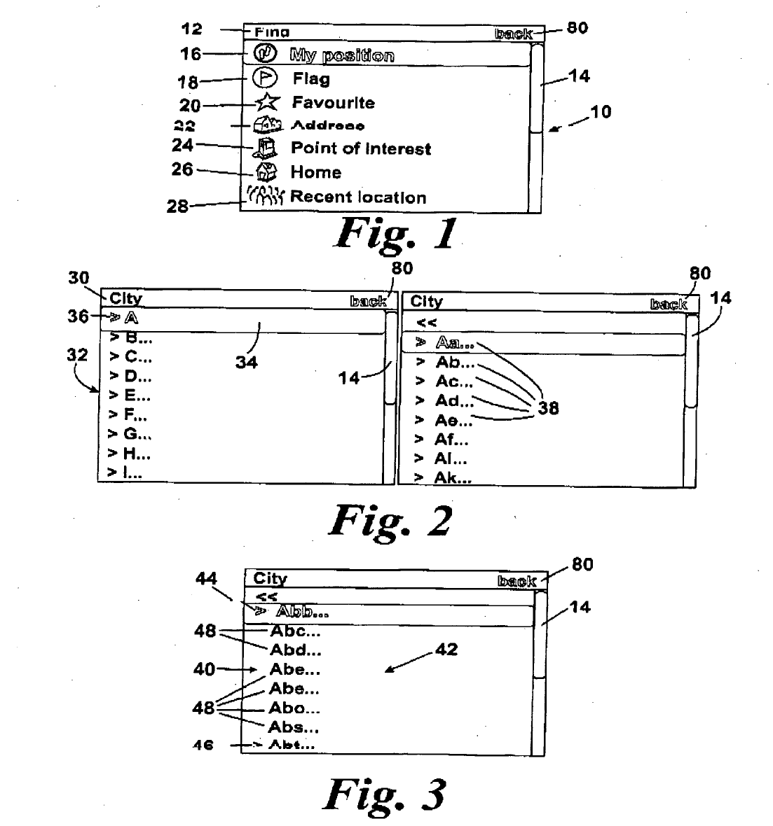

Referring firstly to FIG. 1, the user causes the PND, through suitable selection of a displayed option either by touching a touch-sensitive screen of the device or by using a physical control provided on the device, to enter a “Find” mode. In the screen shot 10, identification of the “Find” mode is made at 12. A user-draggable scroll control 14 is provided at 14, such being caused to move either by means of the user's finger touching the screen in the vicinity thereof and dragging downwardly, or by means of suitable physical control on the device. As can be seen, there are various list entries, namely “My Position” 16, “Flag” 18, “Favourite” 20, “Address” 22, “Point of Interest” 24, “Home” 26, and “Recent Location” 28. The first entry 16 is shown with a background highlight applied to indicate to the user of a device having a scroll wheel that operating such a control in a “select” manner will result in the selection of the highlighted list entry.

Although this invention is described with reference to the finding of an address, it is equally applicable to the finding or identification of other locations.

Accordingly, on selection of the “Address” list entry 22, the user can begin entering a city name for the current country specified in the device memory. Accordingly, the first address portion for which information is required is the “City” identified at 30 in screenshot 32. The list on the screen consists of the alphabet from A to Z, each character thereof being followed by an ellipsis, but as the screens of PNDs are never generally large enough to show a list of 26 entries, the list is made scrollable by means of scroll bar 14. These letters form the first letters of the city names available on the current country map. The highlight 34 defaults to the first option “>A . . . ” 36. The user can scroll through this list, which in the case of the provision of a scroll wheel results in the movement of the highlight indicator bar 34, and can choose any letter by pressing said scroll wheel. In the case of touch-screen entry, the user would simply touch the screen in the vicinity of the scroll bar display the required letter, and then touch the screen in the vicinity of that letter to select it.

Subsequently the user can enter the second letter of the city name, as shown in the second screen shot of FIG. 2. In the embodiment shown, the first letter chosen was “A”, and the second list has entries 38 “Aa . . . ”, “Ab . . . ”, “Ac . . . ” and so on. Again, in accordance with the invention, the selection of list entry “Ab . . . ” results in the display of a further list 42 shown in screenshot 40 in FIG. 3. As can be seen, the list of entries in this further list consist of three characters as at 44, 46, and of completed city names 48.

Ideally, although not essentially, the selection of one of the two character list items from the previous screen in FIG. 2 causes a search to be performed within the device of all the city names for a particular country, and in those cases where only one city exists which begins with the letters, for example “Ab?” where “?” represents any further alphabetic character from “a” to “z”, then that city name is displayed. In the event that multiple city names exist matching that criteria, then a list entry item such as 44, 48 is displayed. Selection of one of the specific city names causes such to be stored in memory, and the find facility to pass to the next routine, as described with reference to FIG. 4 and subsequent figures. Alternatively, selection of one of the list items 46, 48 results in the display of a further list of specific city names matching the criterion described above.

Ultimately, once the selection of a city has occurred, the find facility passes to a broadly identical routine for identifying a more specific address portion, for example a street name, as indicated at 50 in screen 52. Again, an alphabetically sorted list of individual characters “A . . . ” to “H . . . ” is displayed, of course remaining characters “I . . . ” to “Z . . . ” being hidden but scrollably revealable. An additional selectable entry 54 is shown within this list being “City Centre”, and selection of this entry automatically causes the device to set the location as the centre of the city previously chosen, and the address finder function ends. Alternative selection of any of the letters causes the execution of an identical routine to that already described for the city identification.

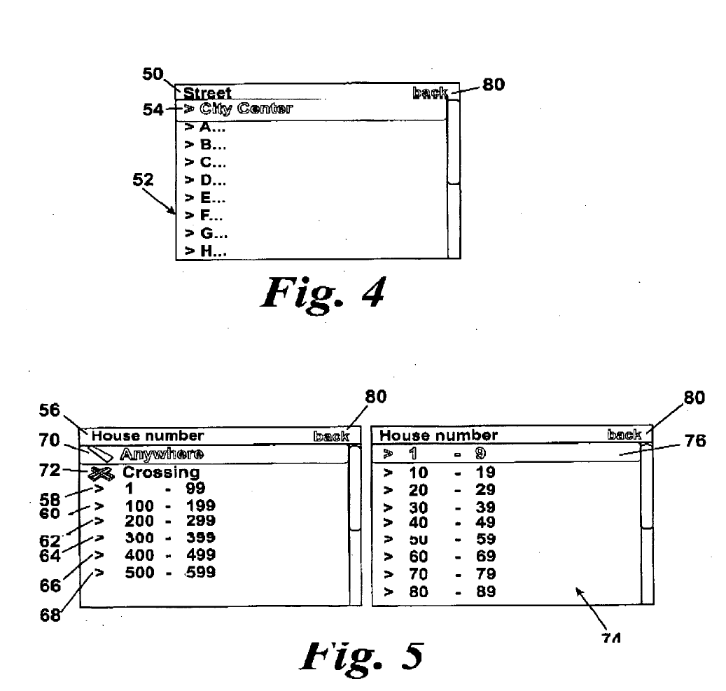

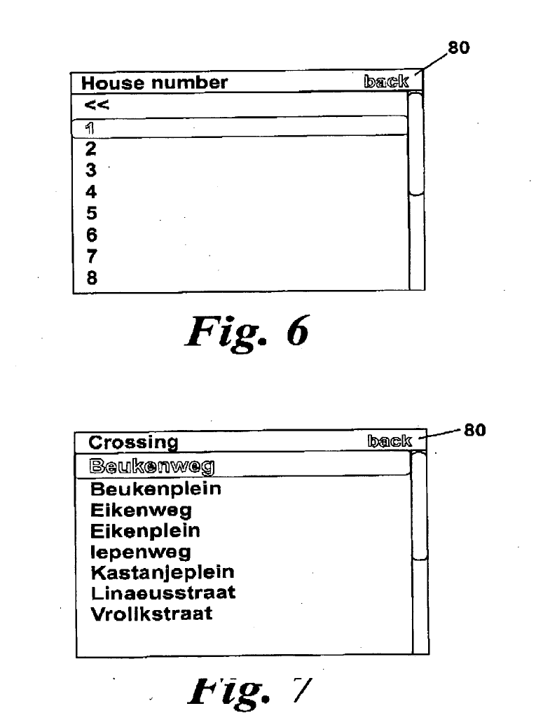

After entering a street, the user can enter a house number, again by means of a similar routine, illustrated in FIG. 5. The address portion identifier is shown at 56, and the list consists of a plurality of number ranges, some of which are shown at 58, 60, 62, 64, 66, 68, and additionally alternate entries 70, 72. The first of these entries 70 is an “Anywhere” entry, selection of which immediately indicates to the device that the user is not interested in identifying a specific number along a particular previously identified street. Accordingly, the routine is ended on selection of this list entry. The second alternate list entry 72 is “Crossing” which results in the display of a further list shown in FIG. 7.

Of course, normally, the user desires to enter a specific number, and accordingly will select one of the first list entries shown in FIG. 5, Specifically, if entry 58 is selected, a second list is displayed of narrower ranges which together cover all those numbers covered in the first selected range identified in list entry 58. These are shown, partially at least, in screen 74 of FIG. 5. Again, selection of the first highlighted entry on this screen 76 causes display of a further list of individual numbers 1-8 (the number “9” is revealable again by scrolling) from which specific identification of the desired number can be made.

Of course, in all embodiments, the lists displayed are ideally sorted alphabetically or numerically, and all screens ideally include a “back” control 80.

Possible modifications of the invention are shown in the remaining FIGS. 8-14, but in general, the principles of the invention are the same. For example in FIG. 8, the lists may include an apostrophe —'— 82 (such falling within the term “alphanumeric” used herein) where city names (or indeed street names) possibly begin with such, e.g. 's-Graveland, 's Gravenhaven in Holland.

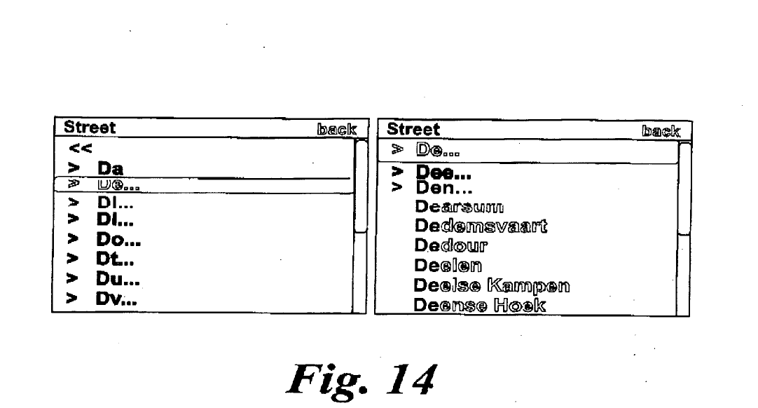

FIGS. 9 and 14 shows how the definite articles, e.g. “La”, “Le”, “L′”, “De”, “Den”, etc., may be accounted for.

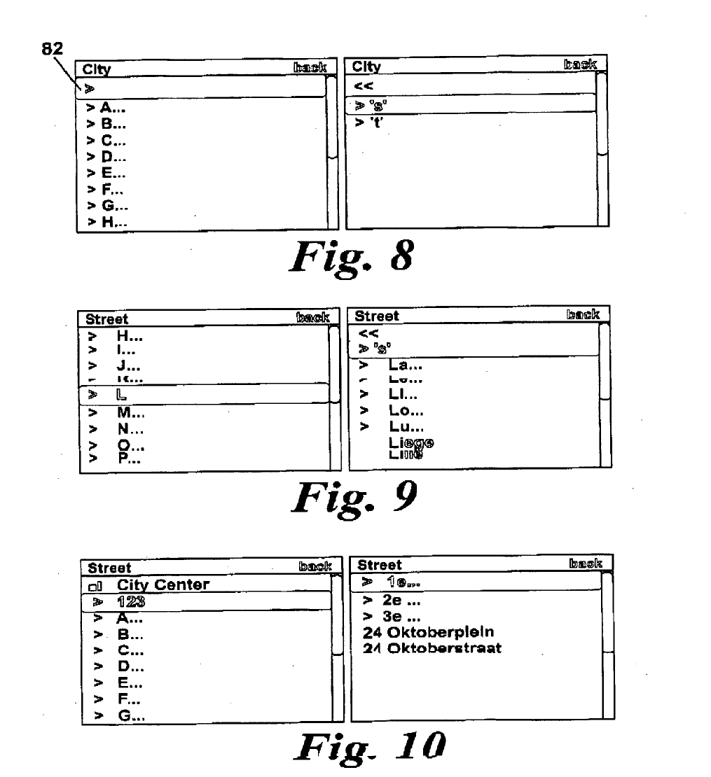

FIG. 10 shows how cities or streets beginning with numerals (1, 2, 3, etc.) or ordinal indications (“First, Second, Third . . . ” etc) may be accounted for.

FIG. 11 shows how cities or streets beginning with abbreviations (e.g. “St.” or “Dr.” etc) may be accounted for.

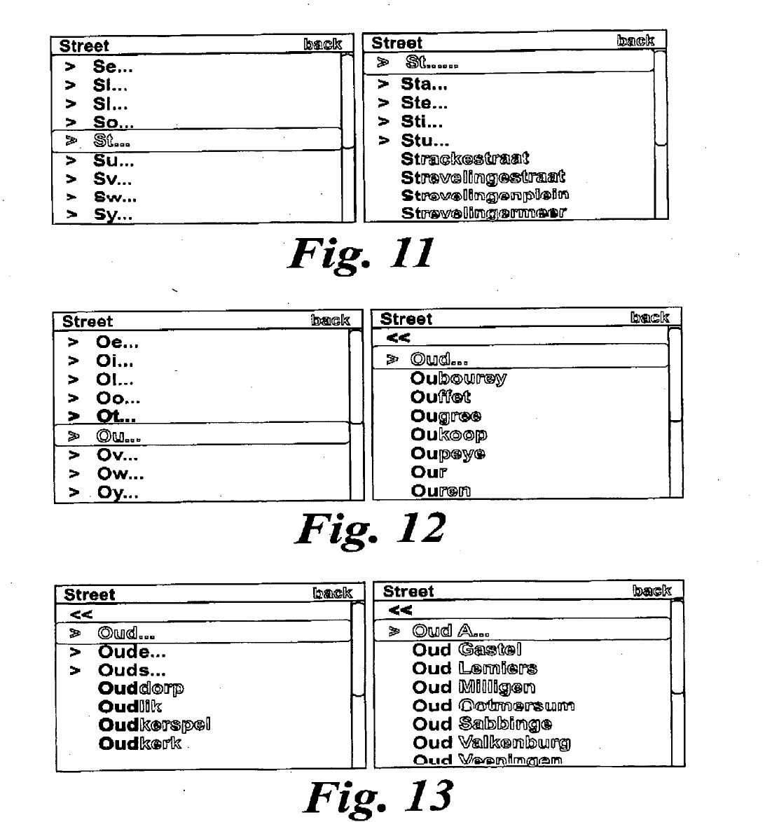

FIGS. 12, 13 shows how cities or streets beginning with adjectives (east west, etc.) may be accounted for.

What is claimed is:

1. A portable navigation device or navigation system comprising:
a display;
memory including one or more map data files comprises digitized map data and descriptive data identifying features represented within said digitized map data;
processing means;
wireless signal reception means;
user interface arranged with said display, memory processing means and reception means to receive user input;
software arranged with said processing means to perform navigation between a current location determined from wireless signals received by said reception means, and a destination at least partially identified by said user input, wherein said software includes an address finding facility which when selected, causes display of at least one address portion identifier on said display together with a first sorted list of consecutive alphanumeric characters being both selectable and representing either
a first alphanumeric character of said address portion identifier, or
a first range of alphanumeric characters between which said address portion identifier exists,
means for displaying a second list of alphanumeric characters in response to selection of an entry in said first list, wherein entries in said second list are selectable and include either
said first alphanumeric character and at least one further alphanumeric character, said further alphanumeric character consecutively changing in said second list, or
a second narrower range of alphanumeric characters, or
individual consecutive alphanumeric characters previously represented by said first range, and
wherein selection of an entry in said second list causes either identification of said address portion identifier or display of further lists being progressively more specific as a result of user selection of entries in previously displayed lists until selection of an entry in one of displayed further lists results in such identification.

2. The device or system according to claim 1, further comprising means for, when said address portion identifier is alphabetically represented, forming said first list to comprise a plurality of entries arranged by consecutive letters and said second list comprising entries including alphabetical characters selected from said first list suffixed by a consecutively changing alphabetical character.

3. The device or system according to claim 2, further comprising means for whereby selection of an entry from said second list causes a search to be conducted of descriptive data stored in said memory for a particular address portion identifier currently being identified, said search being of the “begins with” type and including two alphabetic characters previously selected from said second list, such that subsequently displayed further list comprise entries including said two alphabetic characters suffixed by at least one of one further alphabetic character as a third character and full address portion identifier names as a third character.

4. The device or system according to claim 2, further comprising means for whereby in case a further list of selectable entries is displayed after selection from a previous second list of consecutive pairs of alphabetic characters, said first three alphabetic characters of entries in said further list is displayed differently to a remainder of any fully displayed address portion identifier name.

5. The device or system according to claim 2, further comprising means for whereby, in said first list, said alphabetic character is displayed capitally.

6. The device or system according to claim 5, wherein in said second list, said first, previously selected character is displayed capitally and said second consecutively changing character is displayed adjacent to said first character and in a lower case.

7. The device or system according to claim 1, wherein at least one of said first, second and further lists are scrollable.

8. The device or system according to claim 7, further comprising a display screen and wherein said lists are scrollable by means of a draggable scroll bar additionally displayed on said display screen, such being touch sensitive to allow a user to virtually touch, hold and drag said scroll bar and thus cause display of entries.

9. The device or system according to claim 7, further comprising list scrolling means and means for highlighting an entry in said lists.

10. The device or system according to claim 9, wherein said scrolling means comprises a scroll wheel control.

11. The device or system according to claim 1, wherein said address portion identifier displayed comprises at least one of a city name, a street or road name or indicator, a house or building number or name and an intersection name or indicator.

12. The device or system according to claim 1, wherein, in the case the address portion identifier is numeric, the first, second or further lists comprises at least one entry representing a range of numbers, each of which is selectable to cause display of a second or further list having either
selectable entries representing a plurality of narrower ranges which collectively cover all the numbers represented by the selected entry in the first list, or
selectable entries being individual numeric values
selection of said entries in said second or further list causing either display of a further list having either of said entries or identification of a desired address portion identifier to the device or system, which in conjunction with other selections previously made, contributes to an overall identification of an address location.

13. The device or system according to claim 1, further comprising means for causing said address finding facility to repeat the finding facility when said address portion identifier of an alphanumeric type is identified, said finding facility being either for a more specific alphabetic address portion identifier type, or for a numeric address portion identifier type.

14. The device or system according to claim 1, wherein, when said address portion identifier is numeric and a prior selection of an alphatebetic address portion identifier has been made, said first list further comprises one or more alternate entries, distinct from said numeric range entries, which allow a user to forgo entry of a specific number.

15. The device or system according to claim 14, wherein one of said alternate list entries is an “anywhere” entry, selection of which results in automatic indication to said device or system that anywhere on a previously selected alphabetic address portion identifier is acceptable as a location.

16. The device or system according to claim 15, wherein one of said alternate list entries is a “crossing” entry, selection of which results in display of a further list of alphabetically sorted street or road names crossing or otherwise intersecting with a previously selected alphabetic address portion identifier, selection of any of said entries then resulting in identification of a specific location.
